(19) United States
(12) Patent Application Publication
(10) Pub. No.: US 2009/0004627 A1
(43) Pub. Date: Jan. 1, 2009

(54) Dental Material And Composite Dental Material Formed By Using Hydroxy Apatite

(76) Inventors: Mitsunori Ishimoto, Tokyo (JP); Hidesato Hara, Tokyo (JP)

Correspondence Address: JACOBSON HOLMAN PLLC, 400 SEVENTH STREET N.W., SUITE 600, WASHINGTON, DC, 20004, US

(21) Appl. No.: 11/661,119

(22) PCT Filed: Dec. 15, 2006
(86) PCT No.: PCT/JP2006/325565

§ 371 Date: Jun. 21, 2007

(30) Foreign Application Priority Data
Dec. 16, 2005 (JP) 2005-364010

(51) Int. Cl. A61C 5/00

(52) U.S. Cl. 433/215

(57) ABSTRACT

It is intended to provide a dental material formed by using a hydroxy apatite, which is suitable for performing the guided bone regeneration (GBR) method in the implant therapy of dentistry. Also, it is intended to provide a composite dental material which is a bioabsorbable film provided integrally with hydroxy apatite, which is capable of rapidly attracting the osteoblast and blocking the fibroblast. The dental material is a membrane to be used for a guided bone regeneration method of guiding a bone formation by preventing invasion by anaplastic fibroblast by covering a bone developing site with a blocking membrane and filling the bone developing site with osteoblast, wherein a membrane main body of the blocking membrane is formed by using hydroxy apatite having osteoconductive capability of rapidly attracting osteoblast for the purpose of disposing the hydroxy apatite at a bone developing site side of the membrane main body. The composite dental material is a membrane to be used for a guided bone regeneration method of guiding a bone formation by preventing invasion by anaplastic fibroblast by covering a bone developing site with a blocking membrane and filling the bone developing site with osteoblast, wherein a membrane main body of the blocking membrane is formed by using a bioabsorbable membrane, and the bioabsorbable membrane is integrally provided with hydroxy apatite having osteoconductive capability of rapidly attracting osteoblast and a structure of being disposed at a bone developing site side of the membrane main body.

### FIELD OF THE INVENTION

This invention relates to a dental material using hydroxy apatite (HA), which is to be used for a guided bone regeneration method of guiding bone formation by preventing invasion by the anaplastic fibroblast by covering a bone developing site with a blocking membrane and filling the bone developing site with the osteoblast as well as to a composite dental material which is a bioabsorbable membrane provided integrally with hydroxy apatite.

### BACKGROUND ART

In implant therapy in current dentistry, for example, there are demands for a departure from the conventional implant therapy wherein tooth planting is the primary object and know-how for embedding an implant more aesthetically, functionally, and at an ideal position. For such demands, necessity for bone development has been recognized, resulting in establishment of the GBR method.

GBR is an abbreviation for Guided Bone Regeneration, and, in accordance with the generally accepted concept, the GBR method is a method for guiding bone formation by preventing invasion by the anaplastic fibroblast by covering a bone developing site with a blocking membrane and filling the bone developing site with the osteoblast. As the blocking membrane, two types of membranes, namely a non-absorbable membrane and an absorbable membrane, are used.

Though the non-absorbable membrane is capable of reliably preventing the invasion by fibroblast for long term, a risk of exposure of such blocking membrane is undesirably high since the mucosa covering the membrane can sometimes be divulsed. According to the generally accepted point of view, the exposure problem occurs more frequently with the Mongoloids whose mucosa is relatively thin. In turn, though the absorbable membrane is reduced in exposure risk, it is difficult to block the fibroblast for a long term since the absorbable membrane is rapidly absorbed in vivo.

In view of the foregoing, JP-A-7-236688 discloses the invention of a membrane for increasing the alveolar bone, which has a three layer structure of a collagen sponge layer, a bioabsorbable plastic coating layer, a hydroxy apatite-containing collagen sponge layer. However, for the purpose of achieving the increase of the alveolar bone, the invention utilizes a guided tissue regeneration method (GTR method) wherein a space is formed in the vicinity of a tooth and the alveolar bone to isolate the bone tissue growing from the alveolar bone via the tooth from interference by the soft tissue.

### SUMMARY OF THE INVENTION

This invention has been accomplished in view of the above-described points, and an object thereof is to provide a dental material formed by using hydroxy apatite, which is suitable for practicing a guided bone regeneration (GBR) method in a dental implant therapy. Also, another object of this invention is to provide a composite dental material that is a bioabsorbable membrane provided integrally with hydroxy apatite and is capable of rapidly attracting the osteoblast and blocking the fibroblast.

In order to solve the above problems, this invention implements a membrane to be used for a guided bone regeneration method of preventing invasion by anaplastic fibroblast by covering a bone developing site with a blocking membrane and guiding bone formation by filling the bone developing site with osteoblast, wherein a membrane main body of the membrane is formed by using hydroxy apatite having osteoconductive capability of rapidly attracting the osteoblast in order to dispose the hydroxy apatite on a bone developing site part. The above-described dental material is the single membrane comprising hydroxy apatite, and this invention further encompasses a dental material that has a composite structure wherein a membrane main body of a blocking membrane is formed from a bioabsorbable membrane, and hydroxy apatite having osteoconductive capability for rapidly attracting the osteoblast is disposed on a bone developing site part of the membrane main body.

As is apparent from the above-described structure, since this invention enables to guide the bone formation by forming a space that is prevented from invasion by the anaplastic fibroblast by covering the bone developing site with the blocking membrane and filling the space with the osteoblast, it is possible to compare this invention with the GBR method. The GBR method is an application of the GTR method to the bone tissue regeneration, while this invention has the object of regeneration of a bone defect.

The dental material according to this invention is in the form of a single membrane comprising hydroxy apatite or is in the form of a membrane comprising two elements of the membrane main body formed from the bioabsorbable membrane and hydroxy apatite, and each of the dental materials takes the form of a membrane. The bioabsorbable membrane takes various forms, and it is necessary to block the fibroblast for a certain period of time in this invention. As used herein, the certain period of time means a period during which the space of the bone developing site covered with the blocking membrane is filled with the osteoblast so as to prevent the invasion by anaplastic fibroblast.

Examples of the bioabsorbable membrane satisfying the above conditions include a collagen membrane, a lactic acid/glycol acid copolymer, and the like. Among the above, the collagen membrane is the most preferred.

Hydroxy apatite which is one of elements for forming the dental material and the composite dental material of this invention has the osteoconductive capability of rapidly attracting the osteoblast. Therefore, the hydroxy apatite is used alone for forming the dental material of this invention or disposed on the bone developing site side of the membrane main body which is a separate material to obtain the composite structure. It is intended to accelerate the bone formation by attracting the osteoblast by the presence of hydroxy apatite in the bone developing site side of the membrane main body. Thus, a bone formation period is reduced.

In order to dispose the hydroxy apatite having osteoconductive capability of rapidly attracting the osteoblast on the bone developing site side of the membrane main body, hydroxy apatite in the form of a film is used as the dental material for forming the membrane main body of the blocking membrane by using hydroxy apatite. The hydroxy apatite film takes the form of a sheet and has the size of perfectly covering an affected area and a thickness for preventing invasion by the fibroblast during appropriately proceeding the bone development. It cannot be said that the hydroxy apatite membrane is bioabsorbable, but hydroxy apatite is a main ingredient of teeth and does not cause any trouble if it remains. Therefore, both of non-absorbable hydroxy apatite and slowly-absorbable hydroxy apatite may be used in this invention.

In the case of using the hydroxy apatite in combination with the membrane main body, the hydroxy apatite is disposed on the bone developing site side of the membrane main body and fixed by a certain method. The fixing may be temporary or permanent. That is, it is sufficient to maintain a state wherein the hydroxy apatite is adhered to the membrane main body so that the membrane main body is provided integrally with the hydroxy apatite. Therefore, it is possible to employ an appropriate fixing method depending on the form of the hydroxy apatite such as a powder, particles, a liquid, a gel, and a sheet.

Typical application examples of the hydroxy apatite fixing method include application of hydroxy apatite dissolved into a solvent on the bone developing site side of the membrane main body. With such fixing method, it is possible to appropriately fix the hydroxy apatite to the membrane main body formed from the bioabsorbable membrane.

A region to which the hydroxy apatite is to be fixed may be a whole part or a part of the bone developing site side of two sides of the membrane main body. Other examples of the fixing method may be dipping of the membrane main body into a hydroxy apatite solution dissolved into a solvent, and this method is one of typical application examples.

As described in the foregoing, the composite dental material which is the bioabsorbable membrane provided integrally with hydroxy apatite has at least two elements (the membrane main body formed from the bioabsorbable membrane and the hydroxy apatite), and this means that it is possible to add third or further elements and the like. Examples of the third element include a remedy accelerating unit capable of covering a surface of the hydroxy apatite. Examples of the remedy accelerating unit include platelet-rich plasma (PRP) and the like.

Since each of the dental material formed by using hydroxy apatite and the composite dental material which is the bioabsorbable membrane provided integrally with hydroxy apatite has the structure and the effects as described above, the bone formation is accelerated by the osteoblast that is attracted directly under the membrane rapidly by the hydroxy apatite with the mucosa exposure being avoided thanks to the advantages of the hydroxy apatite and the bioabsorbable membrane, and it is possible to block the fibroblast by the osteoblast attracted by the hydroxy apatite after the membrane is absorbed, thereby achieving the ideal effects that the hydroxy apatite and the bioabsorbable membrane redeem each other's shortcomings. By the above-described characteristics of rapidly attracting the osteoblast and blocking the fibroblast, appropriate practice of the guided bone regeneration (GBR) method in the implant therapy of dentistry is expected.

### BRIEF DESCRIPTION OF THE DRAWINGS

FIG. 1 is a perspective view showing Example 1 of a dental material according to this invention formed by using hydroxy apatite.

FIG. 2 is a partially exploded view showing Example 2 of a composite dental material according to this invention formed by using hydroxy apatite.

FIG. 3 is a partially exploded perspective view showing Example 3 of a composite dental material according to this invention that is a bioabsorbable membrane provided integrally with hydroxy apatite.

FIG. 4 is a diagram showing one application example of the composite dental material according to this invention that is the bioabsorbable membrane provided integrally with the hydroxy apatite, wherein A is a sectional view showing a state of an affected area after incision; B is a sectional view showing a stage of embedding an implant; and C is a sectional view showing a stage of filling a bone graft material.

FIG. 5 is a diagram showing the rest of the application example of FIG. 4, wherein D is a sectional view showing a stage of inserting the composite dental material into a target site; E is a sectional view showing a stage of disposing the composite dental material of this invention to the target site; F is a sectional view showing a stage of fixing the composite dental material of this invention to the target site; and G is a sectional view showing a stage where the affected area is covered perfectly to wait for bone formation.

### REFERENCE NUMERALS

10: composite dental material of bioabsorbable membrane provided integrally with hydroxy apatite
10′: dental material formed by using hydroxy apatite
11: membrane main body
12: hydroxy apatite
13: remedy accelerating unit
15, 16: both sides of membrane main body of Example 1 formed from hydroxy apatite

### DESCRIPTION OF THE PREFERRED EMBODIMENTS

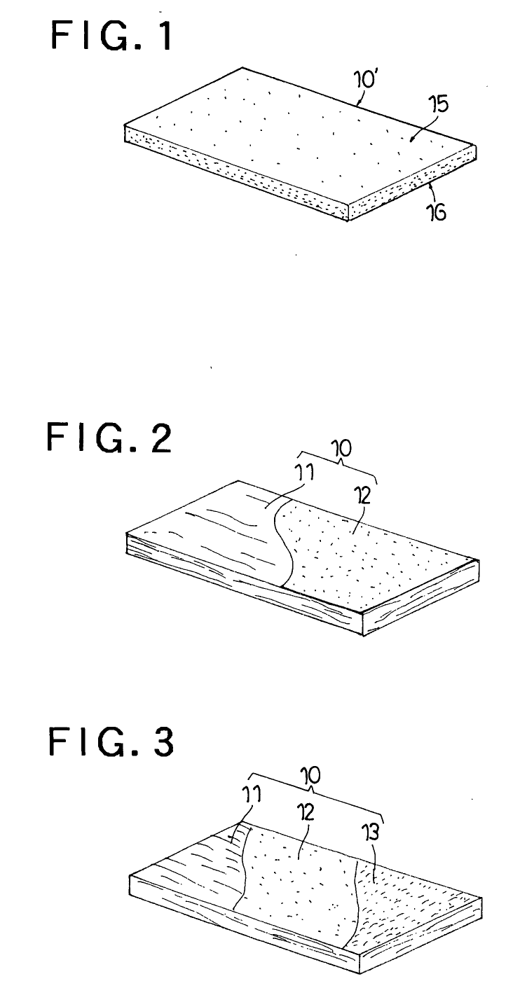

Hereinafter, this invention will be described in more detail with reference to embodiments shown in the drawings. Shown in FIG. 1 is Example 1 of a dental material 10′ formed by using hydroxy apatite. The dental material 10′ is obtained by molding the hydroxy apatite into a sheet-like shape having the size of 1×2 cm, 2×4 cm, or 2×2 cm in plan view and a thickness of 1 to several millimeters. Further, it is possible to achieve a structure wherein the hydroxy apatite of Example 1 is sandwiched by a bioabsorbable membrane from each of both sides 15 and 16.

Shown in FIG. 2 is Example 2 of a composite dental material 10 according to this invention, which is a bioabsorbable membrane 11 provided integrally with hydroxy apatite and has a two-layer structure of a membrane main body 11 formed from the bioabsorbable membrane and hydroxy apatite 12 disposed on and fixed to a bone developing site side of the membrane main body 11.

The membrane main body 11 is formed by using a collagen membrane which is a bioabsorbable membrane. Such membrane main body 11 is a living body-derived membrane such as a cow-derived or pig-derived membrane and has a film-like structure and a handy size in view of convenience in use.

The membrane main body 11 formed from the collagen membrane which is the bioabsorbable membrane functions as a blocking membrane for covering a bone developing site in the implant therapy in dentistry, for example, and used for the purpose of blocking the fibroblast for a certain period of time until a blocking function of the osteoblast is exhibited. In the composite material 10 of this invention, the one having a flat shape, the size of 1×2 cm, 2×4 cm, or 2×2 cm, and a thickness of 1 to several millimeters is usable in the dentistry for the above-described purpose.

The dental material 10′ and the membrane main body 11 have another function of covering the bone developing site to ensure a space, i.e. the function of being used as a constructional material for space-making in the GBR method. Therefore, the membrane main body 11 is required to satisfy conditions for bearing strength required as the constructional material. The above-described shape, dimensions, and the like satisfy the conditions.

The hydroxy apatite 12 has osteoconductive capability of rapidly attracting the osteoblast. In Example 1, the hydroxy apatite 12 is applied so that the hydroxy apatite 12 is disposed at least on the bone developing site side of the membrane main body 11. This is achieved by either one of a method of disposing the hydroxy apatite 12 on both of the bone developing site side and a non-bone developing site side of the membrane main body 11 or a method of impregnating an internal of the membrane main body 11 with the hydroxy apatite 12.

The hydroxy apatite 12 used for the examples is in the form of particles. The hydroxy apatite has an average particle diameter of 20 to 40 mesh or 40 to 60 mesh and is used as being mixed with a water soluble ointment base (Macrogol 400 produced by Sanyo Chemical Industries, Ltd., for example). More specifically, the hydroxy apatite 12 is fixed by applying the hydroxy apatite solution on a whole part of the membrane main body 11. When the solution is used, the hydroxy apatite 12 is fixed not so firmly in some cases, but the object is achieved insofar as the fixing state is maintained until the bone developing site is covered with the blocking membrane formed from the dental material 10 of this invention even when the fixing firmness is relatively weak.

Shown in FIG. 3 is Example 3 wherein a surface of the hydroxy apatite 12 forming the composite dental material 10 of Example 2 shown in FIG. 2 is covered with a remedy accelerating unit 13. In the case of Example 3, the remedy accelerating unit 13 is formed from a platelet-rich plasma gel (PRP gel). It is also possible to fix the remedy accelerating unit 13 to the surface of the hydroxy apatite 12 by applying the remedy accelerating unit 13 on the surface.

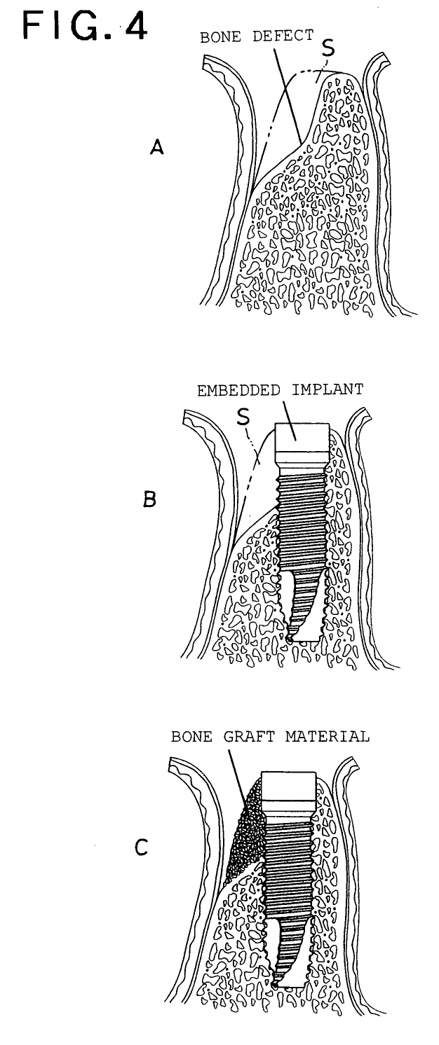

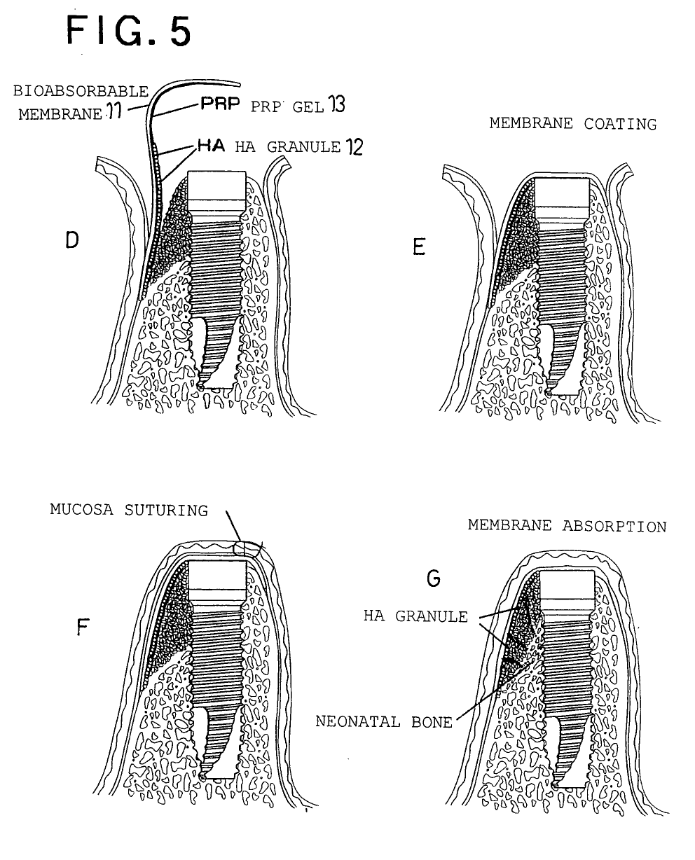

The dental material 10′ formed by using hydroxy apatite and the composite dental material 10 which is the bioabsorbable membrane provided integrally with hydroxy apatite of this invention are prepared under an antiseptic condition and applied on an affected site in use. Examples of the use in the implant therapy in dentistry will be described with reference to FIGS. 4 and 5.

Shown in FIGS. 4 and 5 is one example of performing bone development for the purpose of embedding an implant into the alveolar bone wherein a bone defect has occurred. Shown in FIG. 4A is a state in which the bone defect is exposed by incising the gingiva of the affected site to form a flap, and shown in FIG. 4B is a state in which a required implant is embedded at a target position. The portion enclosed by the two dot chain line is a space S for bone development which is to be covered by the blocking membrane according to this invention for the purpose of prevention of invasion by the anaplastic fibroblast. After performing a predetermined drilling of the alveolar bone to reach the spongy bone, the space S is filled with a bone graft material (FIG. 4C).

Then, the composite dental material 10 of this invention of the bioabsorbable membrane, for example, provided integrally with hydroxy apatite is used as a blocking membrane (FIG. 5D). More specifically, the hydroxy apatite 12 is disposed in such a fashion as to face the space S which is the bone developing site and to cover the bone graft material filled in the space S. The composite dental material 10 shown as the example has the remedy accelerating unit 13 and perfectly covers the bone graft material filled in the space S (FIG. 5E). When the flap of the mucosa is sutured, the composite dental material 10 is in the fixed state (FIG. 5F).

By suturing the mucosa, the composite dental material 10 of this invention is enclosed inside the mucosa to be fixed therein. Therefore, insofar as the hydroxy apatite 12 is fixed to the bone developing site side of the membrane main body 11 until this stage, the hydroxy apatite 12 achieves its object even when the fixing force is not so strong since the hydroxy apatite 12 will not be broken or the like after this stage. After that, by the biological activity, a neonatal bone is generated from the alveolar bone over time. By the osteoconductive capability of the hydroxy apatite 12 of the composite dental material 10, the osteoblast is rapidly and positively attracted, so that acceleration of the bone formation is expected (FIG. 5G).

The rapid bone formation is achieved directly under the membrane as described above, and then the membrane main body 11 is absorbed in vivo over time. After the membrane absorption, the osteoblast attracted by the hydroxy apatite 12 exhibits its blocking function to block the fibroblast. Thus, it is possible to achieve the appropriate bone development with the use of the hydroxy apatite membrane or the bioabsorbable membrane by making use of the advantage of reduced mucosa exposure risk and blocking the fibroblast.

What is claimed is:

1. A dental material which is a membrane to be used for a guided bone regeneration method of guiding a bone formation by preventing invasion by anaplastic fibroblast by covering a bone developing site with a blocking membrane and filling the bone developing site with osteoblast, wherein
a membrane main body of the blocking membrane is formed by using hydroxy apatite having osteoconductive capability of rapidly attracting osteoblast for the purpose of disposing the hydroxy apatite at a bone developing site side of the membrane main body.

2. The dental material according to claim 1, wherein the hydroxy apatite has a structure that a layer of the hydroxy apatite is sandwiched by a bioabsorbable membrane from each of both sides thereof.

3. A composite dental material which is a membrane to be used for a guided bone regeneration method of guiding a bone formation by preventing invasion by anaplastic fibroblast by covering a bone developing site with a blocking membrane and filling the bone developing site with osteoblast, wherein
a membrane main body of the blocking membrane is formed by using a bioabsorbable membrane, and
the bioabsorbable membrane is integrally provided with hydroxy apatite having osteoconductive capability of rapidly attracting osteoblast and a structure of being disposed at a bone developing site side of the membrane main body.

4. The composite dental material of the bioabsorbable membrane provided integrally with the hydroxy apatite according to claim 3, wherein the bioabsorbable membrane is a collagen membrane.

5. The composite dental material of the bioabsorbable membrane provided integrally with the hydroxy apatite according to claim 3, wherein the hydroxy apatite is fixed to the membrane main body as being dissolved into a solvent and applied on the bone developing site side of the membrane main body.

6. The composite dental material of the bioabsorbable membrane provided integrally with the hydroxy apatite according to claim 3, wherein the hydroxy apatite is fixed to the membrane main body as being dissolved into a solvent and dipping the membrane main body into the hydroxy apatite solution.

7. The composite dental material of the bioabsorbable membrane provided integrally with the hydroxy apatite according to claim 3, wherein a surface of the hydroxy apatite is covered with a remedy accelerating unit.
